(19) United States
(12) Patent Application Publication
(10) Pub. No.: US 2018/0040210 A1
(43) Pub. Date: Feb. 8, 2018

(54) System for Emergency Alerts and Related Methods

(71) Applicant: Life Lite, LLC, Phoenix, AZ (US)

(72) Inventor: Tracy Mulac, Phoenix, AZ (US)

(21) Appl. No.: 15/669,507

(22) Filed: Aug. 4, 2017

Related U.S. Application Data
(60) Provisional application No. 62/371,198, filed on Aug. 4, 2016.

(51) Int. Cl. G08B 5/38; G08B 25/01

(52) U.S. Cl. CPC G08B 5/38; G08B 25/016; G06F 19/322

(57) ABSTRACT

Embodiments of a system for emergency alerts are generally described herein. Many embodiments include an alert system. In some embodiments, the alert system can comprise a communications device, a relay coupled to the communications device, and a controller coupled to the relay. In some embodiments, the system can comprise a light coupled to the controller and installed at a location and a memory comprising medical information. In various embodiments, the relay can receive a signal when the communications device sends an emergency communication, the controller can activate the light based at least in part on the signal, and the system sends the medical information from the memory to an emergency system based at least in part on the signal. Other embodiments may be described and claimed.

### CROSS-REFERENCE TO RELATED APPLICATIONS

The present application claims priority to U.S. Provisional Patent Application No. 62/371,198, entitled “LIFE LITE—Emergency Medical Alert Beacon,” filed on Aug. 4, 2016, which is hereby incorporated by reference.

### TECHNICAL FIELD

This disclosure relates generally to the field of emergency alerts, and more particularly to systems for activating alert beacons.

### BACKGROUND

Emergency responders can have difficulty finding the location of an emergency. Sometimes an address of the location can be difficult to find due to non-updated maps, similar addresses, or lack of signage. Emergency responders also can have difficulty relaying emergency information to residents or building occupiers. Thus there exists a need for an emergency alert system that can assist emergency responders in locating the emergency location and/or relaying emergency information.

### BRIEF DESCRIPTION OF THE DRAWINGS

To facilitate further description of the embodiments, the following drawings are provided in which:

FIG. 1 illustrates a front elevation view of a computer system that is suitable for implementing at least part of a central computer system;

FIG. 2 illustrates a representative block diagram of exemplary elements included on the circuit boards inside a chassis of the computer system of FIG. 1;

FIG. 3 illustrates a representative block diagram of a system, according to an embodiment;

FIG. 4 illustrates a representative block diagram of a portion of the system of FIG. 3, according to an embodiment; and

FIG. 5 illustrates is a flowchart for a method, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Many embodiments include an alert system. In some embodiments, the alert system can comprise a communications device, a relay coupled to the communications device, and a controller coupled to the relay. In some embodiments, the system can comprise a light coupled to the controller and installed at a location and a comprising medical information. In various embodiments, the relay can receive a signal when the communications device sends an emergency communication, the controller can activate the light based at least in part on the signal, and the system sends the medical information from the memory to an emergency system based at least in part on the signal.

Various embodiments comprise an alert system. In many embodiments, the alert system can comprise one or more processing modules and one or more non-transitory storage modules storing computing instructions configured to run on the one or more processing modules and perform acts. In some embodiments, the acts can comprise receiving, by a relay, a signal when a communications device sends an emergency communication, sending medical information from a memory to an emergency system based at least in part on the signal, and activating, by a controller coupled to the relay, an alert light located at an emergency location, based at least in part on the signal.

A number of embodiments comprise a method for activating an alert light. In some embodiments, the method can comprise receiving, by a relay, a signal when a communications device sends an emergency communication. In some embodiments, the method can comprise sending medical information from a memory to an emergency system based at least in part on the signal. In many embodiments, the method can comprise activating, by a controller coupled to the relay, the alert light located at an emergency location, based at least in part on the signal.

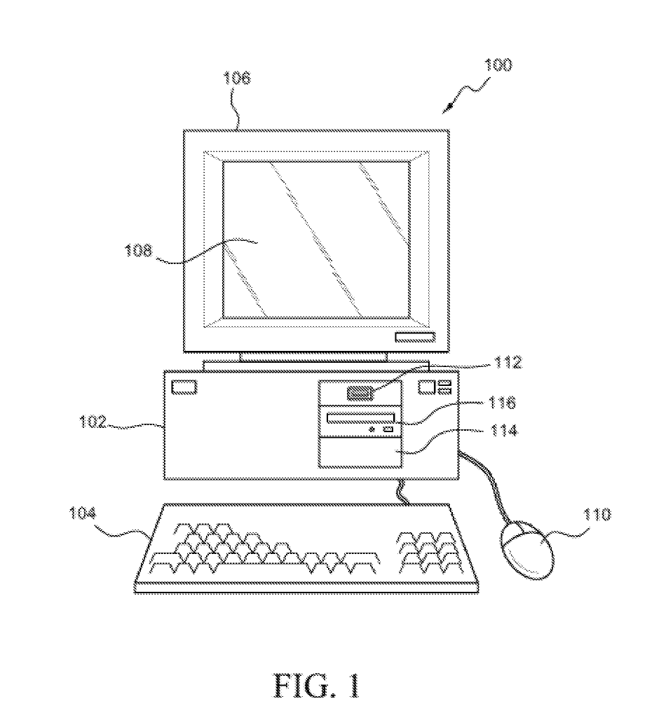

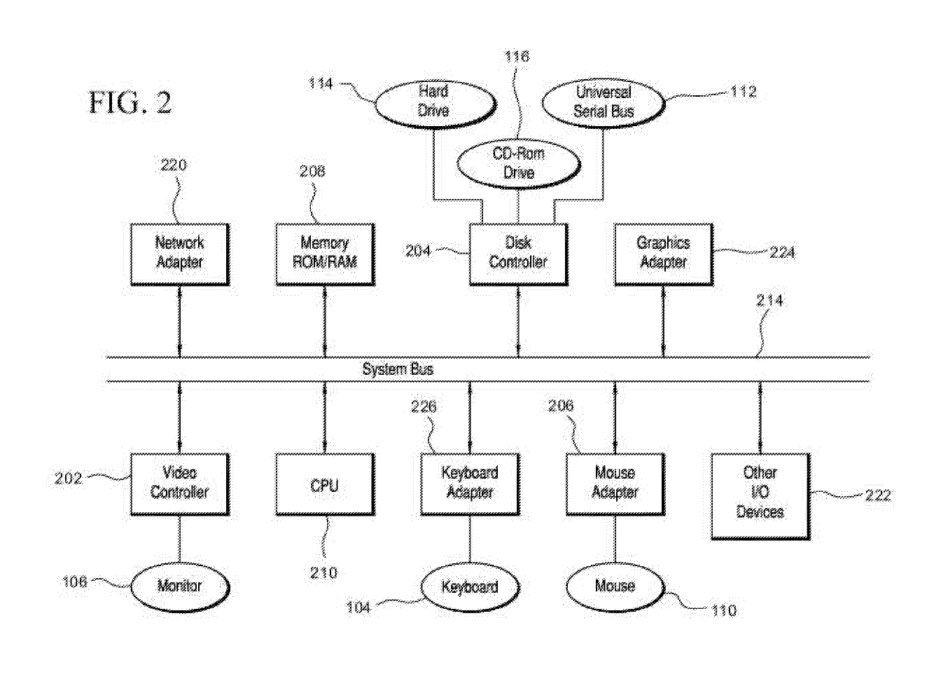

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, random access memory (RAM) and/or (ii) non-volatile (e.g., non-transitory) memory, such as, for example, read only memory (ROM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), CD-ROM and/or DVD drive 116 (FIGS. 1-2), a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone or a tablet. In certain additional embodiments, computer system 100 may comprise an embedded system.

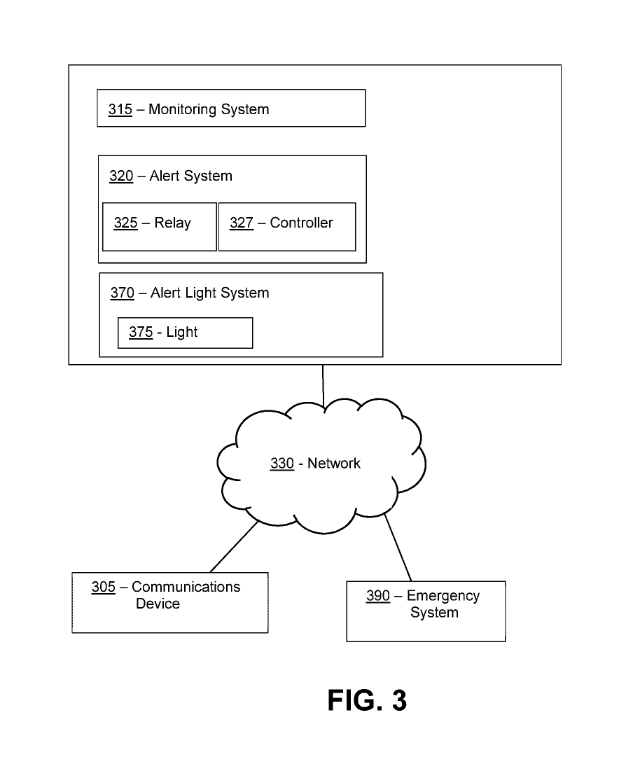

Skipping ahead now in the drawings, FIG. 3 illustrates a representative block diagram of a system 300, according to an embodiment. In many embodiments, system 300 can comprise an emergency alert system. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In a number of embodiments, system 300 can comprise a monitoring system 315, an alert system 320, a relay, a controller, and an alert light system 370. In some embodiments, monitoring system 315, alert system 320, and alert light system 370 can each be a computer system 100 (FIG. 1), as described above, and can each be a single computer, a single server, or a cluster or collection of computers or servers. In some embodiments, monitoring system 320 can be in communication, through a network 330, with an emergency system 390 (e.g., 911, police department, or fire department) and can track when an emergency call has been placed to emergency system 390 through a communications device 305. In some embodiments, an emergency call can comprise a voice call, a short message service (SMS) text, or similar notification. In some embodiments, the communications device 305 can be stored on the computer 100 (FIG. 1), or a separate landline, cellular phone, alarm system, or similar communications device.

In many embodiments, monitoring system 315, alert system 320, and/or alert light system 370 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of monitoring system 315, alert system 320, and/or alert light system 370 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of monitoring system 315, alert system 320, and/or alert light system 370. In a similar manner, the processing module(s) and the memory storage module(s) can be local and/or remote to each other.

In many embodiments, alert system 320 can comprise a relay 325 and a controller 327 coupled to relay 325. In some embodiments, relay 325 is coupled to the communications device 305 through network 330. In some embodiments, relay 325 can receive a signal when communications device 305 sends an emergency communication to the emergency system 390. In some embodiments, the signal is received by relay 325 after an emergency call is activated or placed by communications device 305. In many embodiments, controller 327 can activate a light 375 based at least in part on the signal received by the relay. In some embodiments, controller 327 can activate light 375 in a pattern. In some embodiments, the pattern can indicate the type of emergency and/or change when emergency responders are in route or have arrived. In some embodiments, system 300 can receive an arrival notification indicating that the emergency responders have arrived at the location. In some embodiments, light 375 can be deactivated based at least in part on the arrival notification. In some embodiments, monitoring system 315 can receive alert information from emergency system 390. In some embodiments, alert system 320 can activate light 375 based at least in part on the alert information received from the emergency system 390 (e.g., alert information such as a weather warning, a fire warning, a missing child warning, or the like can be received and light 375 can be activated to inform the residents or others in the surrounding area of the emergency based at least in part on the alert information received). In some embodiments, light 375 can be activated in a pattern based at least in part on the alert information received (e.g., red flashing light for a fire evacuation warning).

In many embodiments, alert light system 370 can comprise light 375. In some embodiments, light 375 can be at least 20,000 lumens. In some embodiments, light 375 can comprise a strobe light and/or a siren. In some embodiments, light 375 can be coupled to a power source. In some embodiments, the power source can further comprise a battery backup. In various embodiments, alert light system 370 can further comprise a manual override switch. In some embodiments, the manual override switch can be located adjacent to or be coupled to light 375. In the same or other embodiments, the manual override switch can be an electronic button or selection key located on system 300 or the user computer.

In many embodiments, monitoring system 315 and/or alert light system 370 can be configured to communicate with one or more user computers. In some embodiments, the one or more user computers can also can be referred to as the communications device 305. In some embodiments, monitoring system 315 and/or alert light system 370 can communicate or interface (e.g. interact) with one or more customer computers (such as customer computers 340 and 341) through a network 330. In some embodiments, network 330 can be an internet, an intranet that is not open to the public, an email system, and/or a texting system. In many embodiments, network 330 can comprise one or more electronic transmission channels. In many embodiments, the electronic transmission channels can comprise an email, a text message, and/or an electronic notice or message. Accordingly, in many embodiments, monitoring system 315 and/or alert light system 370 (and/or the software used by such systems) can refer to a back end of system 300 operated by an operator and/or administrator of system 300, and customer computers 340 and 341 (and/or the software used by such systems) can refer to a front end of system 300 used by one or more customers 350 and 351, respectively. In some embodiments, customers 350 and 351 also can be referred to as users, in which case, customer computers 340 and 341 can be referred to as user computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, monitoring system 315, alert system 320, and/or alert light system 370 also can be configured to communicate with memory. In some embodiments, the memory can comprise one or more databases. The one or more database can comprise a medical database that contains medical information about one or more users. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). In some embodiments, the one or more databases can be stored on a remote server or cloud. Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between monitoring system 315, alert system 320, alert light system 370, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.)

In some embodiments, system 300 also comprises one or more input devices (e.g., one or more keyboards, one or more keypads, one or more pointing devices such as a computer mouse or computer mice, one or more touchscreen displays, microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of system 300. In a similar manner, the processing module(s) and the memory storage module(s) can be local and/or remote to each other. In some embodiments, the emergency call can be placed or communications device 305 can be accessed through the one or more display devices and/or the one or more input devices.

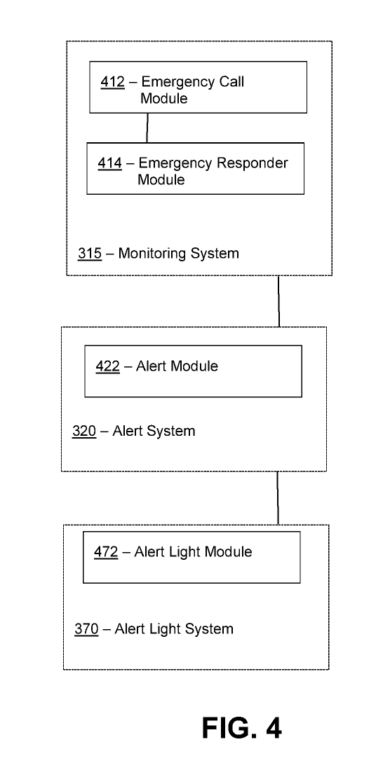

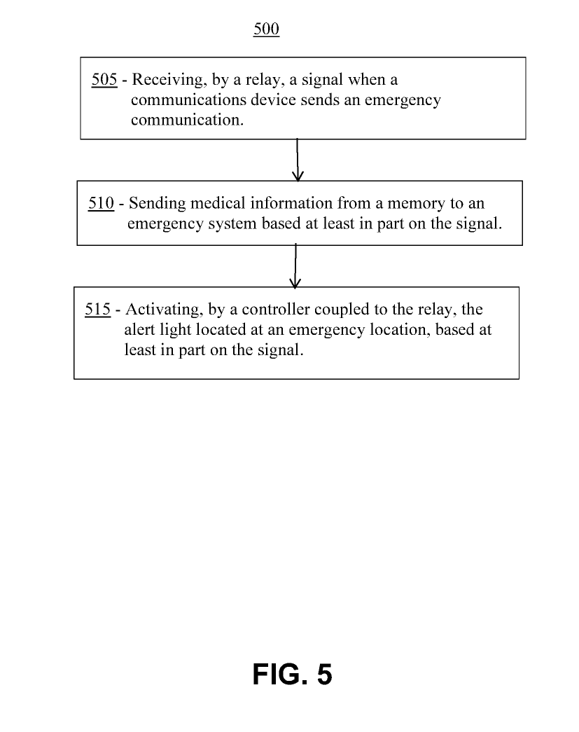

Turning ahead in the drawings, FIG. 5 illustrates a flow chart for a method 500, according to an embodiment. Method 500 is merely exemplary and is not limited to the embodiments presented herein. Method 500 can be employed in many different embodiments or examples not specifically depicted or described herein. In some embodiments, the activities of method 500 can be performed in the order presented. In other embodiments, the activities of method 500 can be performed in any suitable order. In still other embodiments, one or more of the activities of method 500 can be combined or skipped. In many embodiments, system 300 (FIG. 3) can be suitable to perform method 500 and/or one or more of the activities of method 500. In these or other embodiments, one or more of the activities of method 500 can be implemented as one or more computer instructions configured to run at one or more processing modules and configured to be stored at one or more non-transitory memory storage modules 412, 414, 422, and/or 472 (FIG. 4). Such non-transitory memory storage modules can be part of a computer system such as system 300 (FIG. 3), monitoring system 315 (FIGS. 3 & 4), alert system 320 (FIGS. 3 & 4), and/or alert light system 370 (FIGS. 3 & 4). The processing module(s) can be similar or identical to the processing module(s) described above with respect to computer system 100 (FIG. 1).

Turning ahead in the drawings, FIG. 5 illustrates a flow chart for a method 500, according to an embodiment. Method 500 is merely exemplary and is not limited to the embodiments presented herein. Method 500 can be employed in many different embodiments or examples not specifically depicted or described herein. In some embodiments, the activities of method 500 can be performed in the order presented. In other embodiments, the activities of method 500 can be performed in any suitable order. In still other embodiments, one or more of the activities of method 500 can be combined or skipped. In many embodiments, system 300 (FIG. 3) can be suitable to perform method 500 and/or one or more of the activities of method 500. In these or other embodiments, one or more of the activities of method 500 can be implemented as one or more computer instructions configured to run at one or more processing modules and configured to be stored at one or more non-transitory memory storage modules 412, 414, 422, and/or 472 (FIG. 4). Such non-transitory memory storage modules can be part of a computer system such as monitoring system 315 (FIGS. 3 & 4), alert system 320 (FIGS. 3 & 4), and/or alert light system 370 (FIGS. 3 & 4). The processing module(s) can be similar or identical to the processing module(s) described above with respect to computer system 100 (FIG. 1).

In many embodiments, method 500 can comprise an activity 505 of receiving, by a relay, a signal when a communications device sends an emergency communication. In some embodiments, the signal can be received by the relay after the emergency communication is activated by the communications device.

In many embodiments, method 500 can further comprise an activity 510 of sending medical information from a memory to an emergency system 390 based at least in part on the signal. In some embodiments, the medical information can be stored within monitoring system 315 (FIGS. 3 & 4), alert system 320 (FIGS. 3 & 4), and/or alert light system 370 (FIGS. 3 & 4). In some embodiments, the medical information can be stored in memory located within the communications device 305. In some embodiments, the medical information can comprise a profile for each user or resident the location. In many embodiments, the medical information can comprise the medical history for each user. One or more advantages of activity 510 can comprise the medical information being received by the emergency system 390 and sent to the emergency responders and/or the emergency room or hospital. In some embodiments, the emergency system 390 can coordinate medical needs based at least in part on the medical information prior to the arrival of the user.

In some embodiments, method 500 can further comprise an activity 515 of activating, by a controller coupled to the relay, the alert light located at an emergency location, based at least in part on the signal. In some embodiments, the emergency location can be the location of the communications device at the time an emergency call is made. In various embodiments, the emergency location can be a location that is programmed in a user profile associated with the system (e.g., system 300 (FIG. 3)).

In some embodiments, method 500 further can comprise an activity of receiving alert information from an emergency system (e.g., emergency system 390 (FIG. 3)). In many embodiments, method 500 further can comprise activating the light based at least in part on the alert information received from the emergency system. As a non-limiting example, alert information such as a weather warning, a fire warning, a missing child warning, or the like can be received. The method can then activate the light to inform the residents or others in the surrounding area of the emergency based at least in part on the alert information received. In some embodiments, activating the light based at least in part on the alert information received can comprise activating the light in a pattern based at least in part on the alert information received (e.g., red flashing light for a fire evacuation warning).

In many embodiments, the alert light can be coupled to a power source. In some embodiments, the alert system further can comprise a battery backup or a secondary power source coupled to the alert light. In a number of embodiments, the alert light can comprise a strobe light or a siren. In various embodiments, activity 515 of activating the alert light further can comprise activating the alert light in a pattern. In some embodiments, the pattern can comprise a pattern of different colored lights and/or sounds.

In some embodiments, method 500 further can comprise deactivating the alert light by using a manual override switch. In some embodiments, method 500 further can comprise receiving, from the emergency system, an arrival notification that an emergency crew has arrived at the location. In many embodiments, method 500 further can comprise deactivating the alert light based at least in part on the arrival notification. In a number of embodiments, method 500 further can comprise receiving, from the communication device, a cancellation notification cancelling the emergency communication. In some embodiments, method 500 further can comprise deactivating the alert light based at least in part on the cancellation notification.

Returning to FIG. 4, FIG. 4 illustrates a block diagram of a portion of system 300 comprising monitoring system 315, alert system 320, and/or alert light system 370, according to the embodiment shown in FIG. 3. Each of monitoring system 315, alert system 320, and/or alert light system 370 are merely exemplary and are not limited to the embodiments presented herein. Each of monitoring system 315, alert system 320, and/or alert light system 370 can be employed in many different embodiments or examples not specifically depicted or described herein. In some embodiments, certain elements or modules of monitoring system 315, alert system 320, and/or alert light system 370 can perform various procedures, processes, and/or acts. In other embodiments, the procedures, processes, and/or acts can be performed by other suitable elements or modules.

In many embodiments, monitoring system 315 can comprise non-transitory memory storage modules 412 and 414, alert system 320 can comprise non-transitory memory storage module 422, and alert light system 370 can comprise a non-transitory memory storage module 472. Memory storage module 412 can be referred to as an emergency call module 412 and memory storage module 414 can be referred to as an emergency responder module 414. Memory storage module 422 can be referred to as an alert module 422. Memory storage module 472 can be referred to as an alert light module 462.

In many embodiments, emergency call module 412 can store computing instructions configured to run on one or more processing modules and perform one or more acts of methods 500 (FIG. 5) (e.g., activity 505 (FIG. 5)). In some embodiments, emergency responder module 414 can store computing instructions configured to run on one or more processing modules and perform one or more acts of method 500 (FIG. 5) (e.g., activity 510 (FIG. 5)).

In many embodiments, alert module 422 can store computing instructions configured to run on one or more processing modules and perform one or more acts of methods 500 (FIG. 5) (e.g., activity 515 (FIG. 5)). In many embodiments, alert light module 472 can store computing instructions configured to run on one or more processing modules and perform one or more acts of method 500 (FIG. 5) (e.g., activity 515 (FIG. 5)).

While the disclosure has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

Additional examples of such changes have been given in the foregoing description. Accordingly, the disclosure of embodiments of the system for emergency alerts is intended to be illustrative of the scope of systems for emergency alerts and is not intended to be limiting. For example, in one embodiment, FIGS. 3 and 4 are described with reference to medical alert systems, but FIGS. 3 and 4 also can be relevant to other alert systems. Other permutations of the different embodiments having one or more of the features of the various figures are likewise contemplated. It is intended that the scope of the system shall be limited only to the extent required by the appended claims.

The system for emergency alerts and related methods discussed herein may be implemented in a variety of embodiments, and the foregoing discussion of these embodiments does not necessarily represent a complete description of all possible embodiments. Rather, the detailed description of the drawings, and the drawings themselves, disclose at least one preferred embodiment of a system for emergency alerts and related methods, and may disclose alternative embodiments of the same.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. An alert system, comprising:
a communications device;
a relay coupled to the communications device;
a controller coupled to the relay;
a light coupled to the controller and installed at a location; and
a memory comprising medical information;
wherein:
the relay receives a signal when the communications device sends an emergency communication;
the controller activates the light based at least in part on the signal;
and
the system sends the medical information from the memory to an emergency system based at least in part on the signal.

2. The alert system of claim 1, wherein:
the light is coupled to a power source; and
the alert system further comprises a battery backup coupled to the light.

3. The alert system of claim 1, wherein:
the light comprises a strobe light.

4. The alert system of claim 1, wherein:
the signal is received by the relay after an emergency call is activated by the communications device.

5. The alert system of claim 1, wherein:
the controller activates the light in a pattern.

6. The alert system of claim 1, further comprising:
a manual override switch for deactivating the light.

7. An alert system, comprising:
one or more processing modules; and
one or more non-transitory storage modules storing computing instructions configured to run on the one or more processing modules and perform acts of:
receiving, by a relay, a signal when a communications device sends an emergency communication;
sending medical information from a memory to an emergency system based at least in part on the signal; and
activating, by a controller coupled to the relay, an alert light located at an emergency location, based at least in part on the signal.

8. The alert system of claim 7, wherein:
the alert light is coupled to a power source; and
the alert system further comprises a battery backup coupled to the alert light.

9. The alert system of claim 7, wherein:
the alert light comprises a strobe light; and
activating the alert light further comprises activating the alert light in a pattern.

10. The alert system of claim 7, wherein:
the signal is received by the relay after the emergency communication is activated by the communications device.

11. The alert system of claim 7, wherein:
the alert light is deactivated by using a manual override switch.

12. The alert system of claim 7, wherein:
the one or more non-transitory storage modules storing computing instructions are configured to run on the one or more processing modules and further perform acts of:
receiving, from the emergency system, an arrival notification that an emergency crew has arrived at the location; and
deactivating the alert light based at least in part on the arrival notification.

13. The alert system of claim 7, wherein:
the one or more non-transitory storage modules storing computing instructions are configured to run on the one or more processing modules and further perform acts of:
receiving, from the communication device, a cancellation notification cancelling the emergency communication; and
deactivating the alert light based at least in part on the cancellation notification.

14. A method for activating an alert light, comprising:
receiving, by a relay, a signal when a communications device sends an emergency communication;
sending medical information from a memory to an emergency system based at least in part on the signal; and
activating, by a controller coupled to the relay, the alert light located at an emergency location, based at least in part on the signal.

15. The method of claim 14, wherein:
the alert light is coupled to a power source; and
the alert system further comprises a battery backup coupled to the alert light.

16. The method of claim 14, wherein:
the alert light comprises a strobe light; and
activating the alert light further comprises activating the alert light in a pattern.

17. The method of claim 14 wherein:
the signal is received by the relay after the emergency communication is activated by the communications device.

18. The method of claim 14, further comprising:
deactivating the alert light by using a manual override switch.

19. The method of claim 14, further comprising:
receiving, from the emergency system, an arrival notification that an emergency crew has arrived at the location; and
deactivating the alert light based at least in part on the arrival notification.

20. The method of claim 14, further comprising:
receiving, from the communication device, a cancellation notification cancelling the emergency communication; and
deactivating the alert light based at least in part on the cancellation notification.
